(19) United States
(12) Patent Application Publication
(10) Pub. No.: US 2002/0007229 A1
(43) Pub. Date: Jan. 17, 2002

(54) Distributed machine control software architecture

(76) Inventors: Edison T. Hudson, Chapel Hill, NC (US); Ronald G. Genise, Raleigh, NC (US)

Correspondence Address: David B. Ritchie, Thelen Reid & Priest LLP, P.O. Box 640640, San Jose, CA, 95164, US

(21) Appl. No.: 09/802,486

(22) Filed: Mar. 9, 2001

Related U.S. Application Data
(60) Provisional application No. 60/188,561, filed on Mar. 10, 2000.

(51) Int. Cl. G05B 19/04

(52) U.S. Cl. 700/245; 700/247

(57) ABSTRACT

Distributed machine control software architecture permits modular development of complex machine control systems and allows functional subsystems comprised of object modules to be distributed and remotely controlled and monitored. Software applications are broken into logical subsystems with standardized data and transaction interfaces that act as servers and clients. This permits flexible reconfiguration of machine functions for a variety of applications and promotes system security and reliability by isolating modifications to functional subsystems. In addition, functional modules of the same application do not need to reside in the same host, but can be remotely located over local intranet or via public Internet. In machine control applications this permits real-time and time critical process sequence objects to be resident in the local machine controller while the user interface, database and command generator are at any remote network location, including any Internet addressed location. Control can be quickly and temporarily reconfigured to allow a remote operator or specialist to study, monitor, or modify a machine control process.

### RELATED APPLICATIONS

This application claims the benefit of provisional U.S. Pat. application Ser. No. 60/188561 filed on Mar. 10, 2000 in the names of Edison T. Hudson and Ronald G. Genise and commonly assigned herewith.

### FIELD OF THE INVENTION

The present invention relates to machine control systems. More particularly, the present invention relates to a software object-based architecture and method for distributed machine control. The invention has broad applicability to machine systems requiring controllers which control actuators and/or monitor sensors.

### BACKGROUND OF THE INVENTION

Machine control systems are well known in the art. Such systems include, for example, systems for controlling robotic assembly equipment such as pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts forming permanent electrical connections between pads on the PCB and electrical contacts, leads or “pins” on the electrical components.

At present, machine control systems are generally based on one or more centrally located processors disposed with the machine being controlled. Software controlling such processors is generally stand alone software designed to operate solely with the machine. It would be desirable to provide a new approach to machine control which allows certain portions of the control software to be located with the machine, e.g., the portions responsible for real-time control, monitoring and operation, while allowing the user control portions of the software (and associated hardware) to be located at a user control point which may be distant from the machine location and connected to it via an appropriate electrical connection such as the Internet or another data network.

### BRIEF DESCRIPTION OF THE INVENTION

Distributed machine control software architecture permits modular development of complex machine control systems and allows functional subsystems comprised of object modules to be distributed and remotely controlled and monitored. Software applications are broken into logical subsystems with standardized data and transaction interfaces that act as servers and clients. This permits flexible reconfiguration of machine functions for a variety of applications and promotes system security and reliability by isolating modifications to functional subsystems. In addition, functional modules of the same application do not need to reside in the same host, but can be remotely located over local intranet or via public Internet. In machine control applications this permits real-time and time critical process sequence objects to be resident in the local machine controller while the user interface, database and command generator are at any remote network location, including any Internet addressed location. Control can be quickly and temporarily reconfigured to allow a remote operator or specialist to study, monitor, or modify a machine control process.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is an elevational schematic diagram of a placement machine system in which a distributed machine control software architecture would be applied in accordance with a specific embodiment of the present invention.

FIG. 2 is a block diagram of a distributed machine system in accordance with a specific embodiment of the present invention.

### DETAILED DESCRIPTION

Embodiments of the present invention are described herein in the context of a distributed machine control software architecture. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In general, the present invention provides an object module method which, in accordance with a specific embodiment, employs Microsoft's Distributed Common Object Module (DCOM) system available from Microsoft Corporation of Redmond, Wash., or similar technology such as CORBA (Common Object Request Broker Architecture) available under various trade names from Active Software of Santa Clara, Calif., to break software applications into functional modules for distribution among distributed network locations and a local machine system. The functional modules contain a standardized interface for data exchange, transaction processing and error handling. Of these functional modules, real-time and time critical process modules are stored on the local machine system while user interface, database and command generator modules are stored at the distributed network locations. The distributed network locations may be local network locations on a local area network such as Ethernet, remote network locations including any internet address location or combinations of local and remote network locations. The distributed network locations may also be a single local network location or a single remote network location. The user interface, database and command generator modules stored at any of the distributed network locations can be executed by an operator at any of the distributed network locations to control the real-time and time critical process modules on the local machine system. Control at the distributed network locations can be temporary or permanent and can be quickly reconfigured.

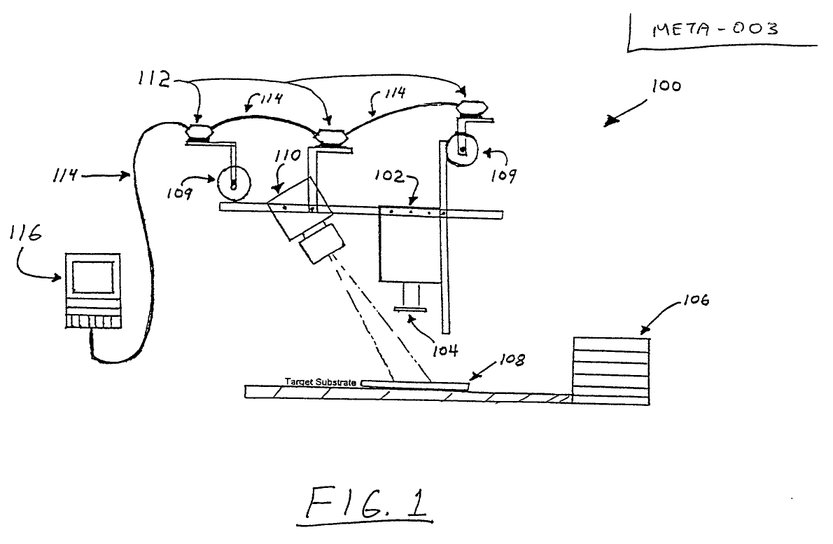

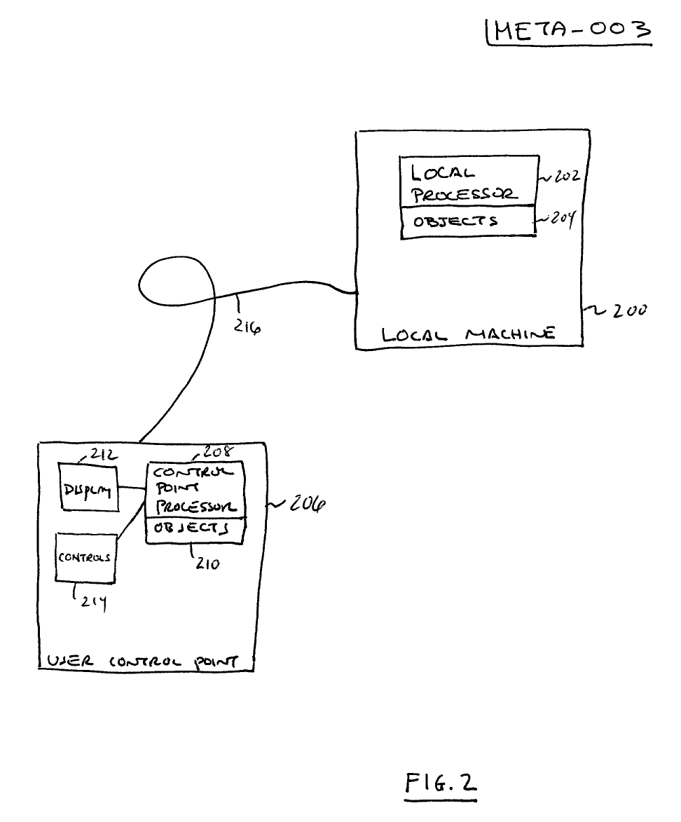

In a specific embodiment of the present invention, the processes of a placement machine are monitored and controlled from local and remote locations as illustrated in FIGS. 1 and 2. The placement machine 100 has a pick-up head 102 which picks up components 104 from storage units 106 and transports them for placement onto a target substrate 108. The components 104 are typically electrical or electro-mechanical components and require highly accurate placement onto the target substrate 108 due to densely packed input/output connections. The placement machine 100 has an imaging system 110 which observes the components 104 and the target substrate 108 in order to measure, register and align under-side contact and edge features of the component 104 to corresponding target substrate 108 features. Real-time processing of images captured by the imaging system 110 permits calculation of coordinate feature locations for components 104 and target substrates 108 and corresponding control of the pick-up head 102 motion to achieve proper registration and alignment between the component 104 and target substrate 108.

In accordance with a specific embodiment of the present invention as applied to the placement machine 100 in FIG. 1, the distributed machine control software permits local and remote operators to view the images captured by the imaging system 110 of the placement machine 100 and control or alter the process accordingly. Real-time functional modules located on the local machine system are used in the vision functions of the placement machine and provide benefits such as the distribution of computational workloads through the assignment of objects for complex tasks to multiple processors connected by the local network. The local network can be any physically distributed network, but is preferably a deterministic local network such as a high speed IEEE 1394 network. In the case of lower speed local networks with bandwidth less than about 100 megabits per second for example, an image object module can be configured from a remote location by an operator executing a remotely stored command generator module to provide real-time data compression, such as MPEG compression, of the locally acquired image prior to transmitting it to the remote network location. This configurable control at the distributed network locations can be temporary or permanent and allows a remote operator to study, monitor or modify a machine control process.

The object module method of the present invention has advantages over conventional programming techniques used for controlling complex machine systems with software implementation. These advantages include increased reliability and security and reduced testing time when making modifications or enhancements to the systems due to isolation of changes to compartmentalized object modules. In addition, less time is necessary to develop new machine control applications due to the ability to quickly combine groups of existing function providing objects in new ways with a minimum of new objects being created. Further, the compatibility of third party software objects implemented in the common object module (COM) method provides general purpose utilities and functionality which speeds up and simplifies complex task implementation.

Turning now to FIG. 2, a local machine 200 operates generally under the control of a local processor 202 running local software objects 204. Local controls and a local display (not shown) may be provided in accordance with common practice. A user control point 206 includes a control point processor 208 running control point software objects 210. A display 212 and appropriate user controls 214 are provided. A network connection 216 couples the user control point 206 to the local machine 200 (and possibly to a number of similar or different local machines (not shown). IN accordance with a specific embodiment of the present invention, user control point software objects 210 are controlled by controls 214 and provide displays to display 212. A common interface associated with the objects provides an interface between the local machine objects and the user control point objects to permit control of the local machine from the user control point with relative ease. Video information developed at the local machine will generally need to be compressed at the local machine before transmission over the network 216 in order to conserve bandwidth.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for controlling a local machine, comprising:
providing a local processor at the local machine, the local processor controlling actuators associated with the machine and coupled to at least one sensor monitoring a condition of the machine;
running a local software object on the local processor, the local software object controlling at least one of an actuator control function and a sensor monitoring function performed by the local processor;
coupling the local machine to a user control point with a network;
providing a user control point processor at the user control point, the user control point processor controlling a display and receiving input from at least one user-operated control;
running a user control point software object on the user control point processor, the user control point software object controlling at least one of a display function and a control input function; and
causing the local software object and the user control point software object to communicate through a common interface over the network.

2. An apparatus for controlling a local machine, comprising:
a local processor disposed at the local machine, the local processor controlling actuators associated with the machine and coupled to at least one sensor monitoring a condition of the machine;
a local software object on the local processor, the local software object controlling at least one of an actuator control function and a sensor monitoring function performed by the local processor;
a network coupling the local machine to a user control point;
a user control point processor disposed at the user control point, the user control point processor controlling a display and receiving input from at least one user-operated control;
a user control point software object on the user control point processor, the user control point software object controlling at least one of a display function and a control input function, wherein the local software object and the user control point software object communicate through a common interface over said network.
